(19) United States
(12) Patent Application Publication
(10) Pub. No.: US 2023/0048365 A1
(43) Pub. Date: Feb. 16, 2023

(54) CORRECTED TRAJECTORY MAPPING

(71) Applicant: HERE Global B.V., Eindhoven (NL)

(72) Inventors: Deekshant Saxena, Mumbai (IN); Senjuti Sen, Manpada (IN)

(21) Appl. No.: 17/399,777

(22) Filed: Aug. 11, 2021

(51) Int. Cl. B60W 60/00; G06K 9/62

(52) U.S. Cl. CPC B60W 60/001; G06K 9/6256; B60W 2520/16; B60W 2520/18; B60W 2520/14

(57) ABSTRACT

A method and apparatus for defining a model to determine a corrected trajectory of a mobile device or vehicle and a method and apparatus for determined a corrected trajectory using a defined model are provided. The model for determining a corrected trajectory includes accessing ground truth location data for a selected pathway, determining a GNSS pathway of a mobile device or vehicle, determining an IMU pathway of a mobile device or vehicle, and calculating an aggregated displacement trajectory. The apparatus for defining the model includes a communication interface configured to receive a first and second pathway, a memory configured to store a model and ground truth location data, and a processor to train the model.

### FIELD

The present application relates to determining the trajectory of a mobile device, and more specifically, to determining a corrected trajectory determination using a neural network.

### BACKGROUND

The Global Positioning System (GPS) or another global navigation satellite system (GNSS) provides location information to a receiving device anywhere on Earth as long as the device has a substantial line of sight without significant obstruction to three or four satellites of the system. The GPS system is maintained and made available by the United States government. Originally, the government retained exclusive use of GPS. Over time increasing levels of accuracy of the GPS signals were made available to the public.

Accuracy of the GPS system alone is about 50 feet or 15 meters. The accuracy may be augmented using secondary techniques or systems such as the Wide Area Augmentation System (WAAS), Differential GPS (DGPS), inertial navigation systems (INS) and Assisted GPS. WAAS and DGPS improve accuracy using ground stations that transmit position information. INS utilizes internal sensors at the receiving device for improving the accuracy of GPS. However, the accuracy may not meet standards necessary for some applications such as autonomous driving.

### SUMMARY

In one embodiment, a method for defining a model to determine the trajectory of a mobile device includes accessing ground truth data for a selected pathway, determining, via a global navigation satellite system, a GNSS pathway of a first probe over the selected pathway, determining, via an inertial measurement unit (IMU), an IMU pathway of a second probe over the selected pathway, calculating an aggregated displacement trajectory of the mobile device along the selected pathway using the GNSS pathway, the IMU pathway, and the ground truth data for the selected pathway, and defining a model configured to estimate the trajectory of a mobile device based on the aggregated displacement trajectory.

In one embodiment, a method for determining a corrected trajectory of a mobile devices includes determining, via a global navigation satellite system, a GNSS pathway of a first probe over a pathway traveled by the mobile device, inputting the GNSS pathway into a defined model, and receiving a corrected trajectory from the model based on at least the subsequent GNSS data.

In one embodiment, an apparatus for defining a model for estimating trajectories comprises a communication interface configured to receive a first measured pathway and a second measured pathway, a memory storing the first measured pathway, the second measured pathway, and a model, and a processor configured to access the memory and calculate an aggregated displacement trajectory using the first measured pathway, second measured pathway, and ground truth location data for a selected pathway.

In one embodiment, an apparatus for determining a corrected trajectory of a mobile device comprises a communication interface configured to receive at least one measured pathway, a memory storing the measured pathway and a defined model, a processor configured to access the memory and execute the defined model using at least the first measured pathway, wherein the model determines a corrected trajectory based on at least the measured pathway.

### BRIEF DESCRIPTION OF THE DRAWINGS

Exemplary embodiments of the present disclosure are described herein with reference to the following drawings.

FIG. 1 illustrates a system for defining a model capable of determining a corrected trajectory of a mobile device, the system also being capable of determining a corrected trajectory of the mobile device using a defined model.

FIG. 2 illustrates a framework for the system of defining a model capable of determining a corrected trajectory of a mobile device, the system also being capable of determining a corrected trajectory of a mobile device using a defined model.

FIG. 3 is a graphical representation of pathways of a mobile device and an aggregated displacement pattern with respect to time.

FIG. 4 illustrates an example framework for the system of defining a model for determining the trajectory of a mobile device according to an exemplary embodiment of the present disclosure.

FIG. 5 illustrates an example framework for the system of determining a corrected trajectory of a mobile device according to an exemplary embodiment of the present disclosure.

FIG. 6 illustrates an example flow chart for defining a model for estimating a trajectory according to an exemplary embodiment of the present disclosure.

FIG. 7 illustrates an apparatus for determining a corrected trajectory of a mobile device according to an exemplary embodiment of the present disclosure.

FIG. 8 illustrates an example flow chart for determining a corrected trajectory of a mobile device according to an exemplary embodiment of the present disclosure.

FIG. 9 illustrates a vehicle in accordance with an embodiment of the present disclosure.

FIG. 10 illustrates an exemplary geographic database.

FIG. 11 illustrates an exemplary geographic database.

### DETAILED DESCRIPTION

Neural networks may be employed to analyze the trajectory of a mobile device. The trajectory of a mobile device may be represented by a pathway. The pathway of a mobile device may be represented graphically by nodes and edges with respect to time. The nodes may represent a location in space with respect to time. The edges may connect the nodes and represent the trajectory of a mobile device with respect to time. The pathway of a mobile device, and corresponding nodes and edges, may be determined using GNSS. The pathway of a mobile device, and corresponding nodes and edges, may be determined using an inertial measurement unit (IMU).

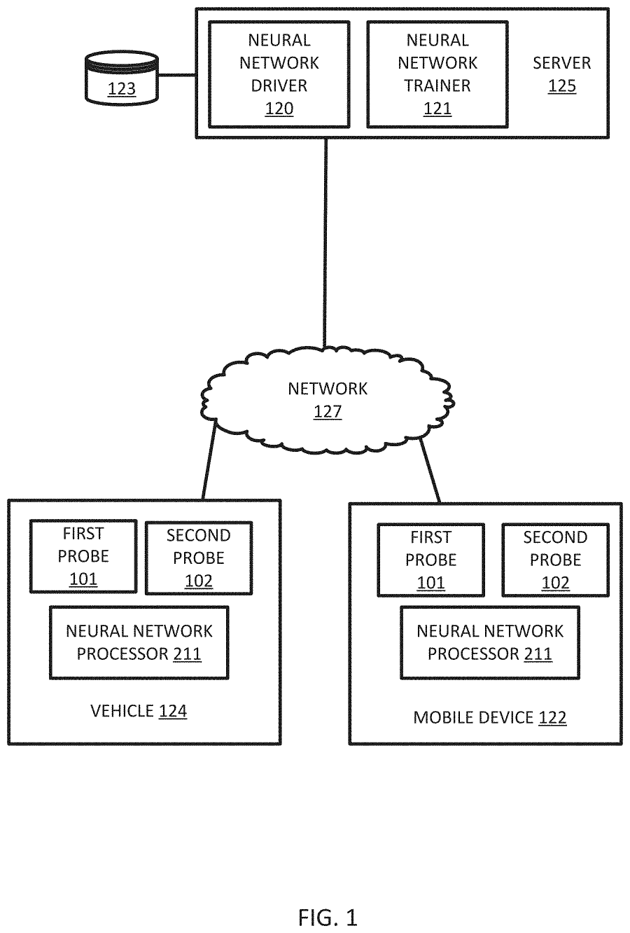

FIG. 1 illustrates a system for defining a model capable of determining a corrected trajectory of a mobile device. The system is capable of determining the corrected trajectory of a mobile device using a defined model.

The system for defining a model capable of determining a corrected trajectory of a mobile device in FIG. 1 includes a server 125. The server 125 is connected to one or more vehicle(s) 124 and/or a mobile device(s) 122 via a network 127. The server may further be connected to a database 123. The database 123 may store the model and ground truth location data. Additional, different, or fewer components may be included.

The mobile device 122 and/or vehicle 124, or multiple mobile devices 122 and vehicles 124 may be connected to the server 125. A vehicle 124 may be connected to a server via a mobile device 122. The server 125 exchanges (e.g., receives and sends) data from the one or mobile devices 122 and/or vehicles 124 via the network 127.

Communication between the vehicles 124 and/or between the mobile device 122 and the server 125 through the network 127 may use a variety of types of wireless networks. Example wireless networks include cellular networks, the family of protocols known as WiFi or IEEE 802.11, the family of protocols known as Bluetooth, or another protocol. The cellular technologies may be analog advanced mobile phone system (AMPS), the global system for mobile communication (GSM), third generation partnership project (3GPP), code division multiple access (CDMA), personal handy-phone system (PHS), and 4G or long term evolution (LTE) standards, 5G, DSRC (dedicated short range communication), or another protocol.

In some embodiments, the mobile device(s) and/or vehicle(s) 124 may include a neural network processor 211 and a neural network trainer. In these embodiments the mobile device(s) 122 and/or vehicle(s) 124 may be configured to define the model using their respective neural network processor 211 and neural network trainer. The mobile device(s) 122 and/or vehicle(s) 124 may collect location data using a first probe 101 and a second probe 102. The neural network trainer may define the model using various location data gathered by the one or more mobile device(s) 122 and/or vehicle(s) 124 and ground truth location data. The neural network trainer may calculate a difference in location between the various location data collected by the mobile device(s) 122 and/or vehicle(s) 124 and ground truth location data. The neural network trainer may use the calculated difference to define the model.

In some embodiments, the server includes a neural network driver 120 and a neural network trainer 121. In this embodiment, the server 125 may be configured to define the model using the neural network driver 120 and the neural network trainer 121. The one or more mobile device(s) 122 and/or vehicle(s) 124 may collect location data via a first probe 101 and a second probe 102. The neural network trainer 121 may calculate a difference between the various location data collected by the mobile device(s) 122 and/or the vehicle(s) 124 and ground truth location data. The neural network trainer 121 may use the calculated difference to define the model.

Each mobile device 122 and/or vehicle 124 may include position circuitry for a first probe 101 and/or a second probe 102 such as one or more processors or circuits for generating probe data.

The first probe 101 may collect GNSS location data of the mobile device 122 or vehicle 124. The first probe may generate GNSS location data by receiving GNSS signals and comparing the GNSS signals to a clock to determine the absolute or relative position of the mobile device 122 and/or vehicle 124. Absolute and relative positions of the mobile device 122 and/or vehicle 124 may be determined at multiple locations such that a first measured pathway of the mobile device 122 or vehicle 124 is defined. The GNSS location data collected by the first probe 101 may comprise a plurality of nodes. The nodes collected by the first probe 101 may be a plurality of GNSS coordinates in space. The nodes collected by the first probe 101 may be a plurality of undirected nodes. The undirected nodes may be a plurality of GNSS coordinates collected, without indication as to which GNSS coordinate comes relative to the other GNSS coordinates sequentially. In some embodiments, the first probe 101 may also collect inertial data of the mobile device 122 and/or vehicle 124. In some embodiments the inertial data collected by the first probe 101 is gyroscope data. In some embodiments, the first probe may collect data indicative of the pose, pitch, roll, and/or yaw of the mobile device 122 or vehicle 124.

Each mobile device 122 and/or vehicle 124 may include a second probe 102. The second probe may collect inertial location data of the mobile device 122 or vehicle 124. The second probe 102 may be an inertial measurement unit (IMU). The second probe 102 may include one or more accelerometers. The second probe 102 may include one or more gyroscopes. The second probe 102 may include one or more magnetometers. The second probe 102 may determine the pose of the mobile device 122 or vehicle 124. The second probe 102 may determine the velocity of the mobile device 122 or vehicle 124. The second probe 102 may collect inertial location data of the mobile device 122 or vehicle 124 at multiple locations, such that a second measured pathway of the mobile device 122 or vehicle 124 is defined. The second probe 102 may determine an IMU location of the mobile device 122 or vehicle 124 using the pose and velocity of the mobile device 122 or vehicle 124. The IMU location of the mobile device 122 or vehicle 124 may comprise a plurality of nodes. The nodes determined by the second probe may be a plurality of IMU coordinates identifying locations of the mobile device 122 or vehicle 124. In some embodiments, the second probe 102 may further be configured to determine the pitch, roll, and yaw of the mobile device 122 or vehicle 124 at multiple locations.

The probe data may include a geographic location such as a longitude value and a latitude value. In addition, the probe data may include a height or altitude. The probe data may be collected over time and may include timestamps. In some examples, the probe data is collected at a predetermined time interval (e.g., every second, ever 100 milliseconds, or another interval). In some examples, the probe data is collected in response to movement by the first probe 101 and/or second probe 102 (i.e., the probe reports location information when the probe 101 moves a threshold distance). The predetermined time interval for generating the probe data may be specified by an application or by the user. The interval for providing the probe data from the mobile device 122 and/or vehicle 124 to the server 125 may be may the same or different than the interval for collecting the probe data. The interval may be specified by an application or by the user.

The neural network trainer 121 may define the model using the first measured pathway defined by the first probe 101, a second measured pathway defined by the second probe 102, and ground truth location data. The neural network trainer 121 may calculate a difference between the first measured pathway and the ground truth location data. The neural network trainer 121 may calculate a difference between the second measured pathway and the ground truth location data. The neural network trainer 121 may define the model using the difference between the first measured pathway and the ground truth location data and the difference between the second measured pathway and the ground truth location data. The ground truth data may describe the actual location of the pathway as determined previously. The ground truth may be determined by highly accurate equipment, for example, equipment have a higher accuracy and/or higher resolution that the first probe 101 and the second probe 102.

In some embodiments a first difference (d1) is calculated between the ground truth data for a selected pathway and the first measured pathway. In some embodiments a second difference (d2) is calculated between the ground truth data for the selected pathway and the second measured pathway. The first difference and the second difference may be summed to define an aggregated displacement trajectory. That is, the aggregated displacement trajectory may be calculated using at least in part the difference between the ground truth data for the selected pathway and the first measured pathway. The aggregated displacement trajectory may be calculated using at least in part the difference between the ground truth data for the selected pathway and the second measured pathway.

Equation 1 below may be used to determine which equation will be used to calculate the aggregated displacement trajectory.

If \sqrt{x₁²−x₂²+y₁²−y₂²}>\sqrt{x₃²−x₂²+y₃²−y₂²}∥\sqrt{x₃²−x₁²+y₃²−y₁²} [Eq. 1]

In the above equation, X₁ represents a first location coordinate in a first plane and Y₁ represents a first location in a second plane, where X₁ and Y₁ collectively represent a first location on a two-dimensional plane. For example, X₁ and Y₁ may represent a first location of a mobile device. Similarly, X₂ represents a second location in a first plane and Y₂ represents a second location in a second plane and X₂ and Y₂ may collectively represent a second location on a two-dimensional plane. Similarly, X₃ represents a third location in a first plane and Y₃ represents a third location in a second and X₃ and Y₃ may collectively represent a third location on a two-dimensional plane.

Equation 2 below may be used to calculate the aggregated displacement trajectory if Equation 1 above is satisfied.

Σₖ₌₀ⁿ(ₖⁿ)Δd=\sqrt{x₃²−xₘ²+y₃²−yₘ²} P[ ]=d₃ [Eq. 2]

In Equation 2, m is derived from y=mx+c using coordinates for d₁ and d₂ where d₁ is a coordinate in two-dimensional space on the first measured pathway and d₂ is a coordinate in two-dimensional space on the second measured pathway, wherein d₁ and d₂ are determined by the first probe 101 and second probe 102, respectfully, when the vehicle is in the same location (i.e., at the same point in time). For example, d₁ may be represented by coordinates x₁ and y₁. In Equation 2, d₃ is coordinates in two-dimensional space for the ground truth location data at the location at which the first probe 101 determines d₁ and the second probe 102 determines d₂. In Equation 2, x₃ and y₃ are a coordinate in a first plane and a coordinate in a second plane, respectively, of the location d₃. In Equation 2, d is the average of the distance between d₁ and d₃ and the distance between d₂ and d₃.

Further, Equation 2 is used to calculate the aggregated displacement trajectory when d₁ and d₂ are on opposite sides of d₃ when d₁, d₂, and d₃ are represented graphically with respect to time.

Equation 3 below may be used to determine the aggregated displacement trajectory when Equation 1 above is not satisfied.

Σₖ₌₀ⁿ(k)Δd=\sqrt{x₃²−xₘ²+y₃²−yₘ²} P[ ]=d₃ [Eq. 3]

Similarly, in Equation 3, m is derived from y=mx+c using coordinates for d₁ and d₂ where d₁ is a coordinate in two-dimensional space on the first measured pathway and d₂ is a coordinate in two-dimensional space on the second measured pathway, wherein d₁ and d₂ are determined by the first probe 101 and second probe 102, respectfully, when the vehicle is in the same location (i.e., at the same point in time). For example, d₁ may be represented by coordinates x₁ and y₁. In Equation 3, d₃ is coordinates in two-dimensional space (i.e., x₃ and y₃) for the ground truth location data at the location at which the first probe 101 determines d₁ and the second probe 102 determines d₂. In Equation 3, x₃ and y₃ are a coordinate in a first plane and a coordinate in a second plane, respectively, of the location d₃. In Equation 3, d is the average of the distance between d₁ and d₃ and the distance between d₂ and d₃.

Further, Equation 3 is used to calculate the aggregated displacement trajectory when d₁ and d₂ are on the same side of d₃ when d₁, d₂, and d₃ are represented graphically with respect to time.

The aggregated displacement trajectory may be used to define a model capable of determining a corrected trajectory of the mobile device 122 or vehicle 124. The model may be a convolutional network. The model may be a spatio temporal graph convolutional network. Embeddings of the aggregated displacement trajectory may be used to define the model. Embeddings of the aggregated displacement trajectory in time may be used to define the model.

The one or more mobile devices 122 and/or vehicles 124 may include mapping applications, navigational applications, or driving applications, which utilize the neural network analysis of data collected at the vehicle. The driving applications may generate warnings or other messages for a driver or passenger of the vehicle. The mapping applications may provide maps including the location of the vehicle as determined by the localization. The navigational applications may present routes (e.g., turn-by-turn directions) that are calculated according to the neural network analysis of data collected at the vehicle.

The one or more mobile devices 122 and/or the vehicles 124 may include local databases corresponding to a local map, which may be modified by the server 125 using the database 123. The mobile devices 122 may be standalone devices such as smartphones or devices integrated with vehicles. In some embodiments the local maps are modified according to data collected by the mobile device 122 or vehicle 124. In other embodiments, the collected data is transferred to the server 125 for augmenting the database 123.

The system for determining a corrected trajectory of a mobile device according to FIG. 1 includes a server 125. The server is connected to a mobile device 122 or a vehicle 124 via a network 127. The system may further include a database 123 connected to the server 125 and configured to store the defined model.

The mobile device 122 or vehicle 124 may include a first probe 101. The first probe 101 may collect GNSS location data of the mobile device 122 or vehicle 124. The first probe may generate GNSS location data by receiving GNSS signals and comparing the GNSS signals to a clock to determine the absolute or relative position of the mobile device 122 and/or vehicle 124. Absolute and relative positions of the mobile device 122 and/or vehicle 124 may be determined at multiple locations such that a first measured pathway of the mobile device 122 or vehicle 124 is defined. The GNSS location data collected by the first probe 101 may comprise a plurality of nodes. The nodes collected by the first probe 101 may be a plurality of GNSS coordinates in space. The nodes collected by the first probe 101 may be a plurality of undirected nodes. The undirected nodes may be a plurality of GNSS coordinates collected, without indication as to which GNSS coordinate comes relative to the other GNSS coordinates sequentially. In some embodiments, the first probe 101 may also collect inertial data of the mobile device 122 and/or vehicle 124. In some embodiments the inertial data collected by the first probe 101 is gyroscope data. In some embodiments, the first probe may collect data indicative of the pose, pitch, roll, and/or yaw of the mobile device 122 or vehicle 124.

In some embodiments, the mobile device 122 or vehicle 124 may include a neural network processor 211 configured to operate or execute a defined model. The neural network processor may input the first measured pathway determined by the mobile device 122 or vehicle 124 into the defined model. The defined model may contain embeddings of aggregated displacement trajectory with respect to time. The neural network processor 211 may determine a corrected trajectory of the mobile device 122 or vehicle 124 using at least the first measured pathway of the mobile device 122 or vehicle 124 and the defined model. The defined model may be configured to estimate the trajectory of the mobile device 122 or vehicle 124 using at least the first measured pathway and the defined model. The neural network processor 211 may estimate the trajectory of the mobile device 122 or vehicle 124 using the first measured pathway and the defined model.

In other embodiments, the mobile device 122 or vehicle 124 may communicate with the server 125 via the network 127. The mobile device 122 or vehicle 124 may send the first measured pathway determined by the first probe 101 to the server 125 via the network 127. The server 125 may include a neural network driver 120 configured execute a defined model. The neural network driver may input the first measured pathway into the defined model. The neural network driver 120 may determine a corrected trajectory of the mobile device 122 or vehicle 124 using at least the first measured pathway and the defined model. The server may send the corrected trajectory to the mobile device 122 or vehicle 124 via the network 127. The defined model may be configured to estimate the trajectory of the mobile device 122 or vehicle 124 using at least the first measured pathway and the defined model. The neural network driver 120 may estimate the trajectory of the mobile device 122 or vehicle 124 using the first measured pathway and the defined model.

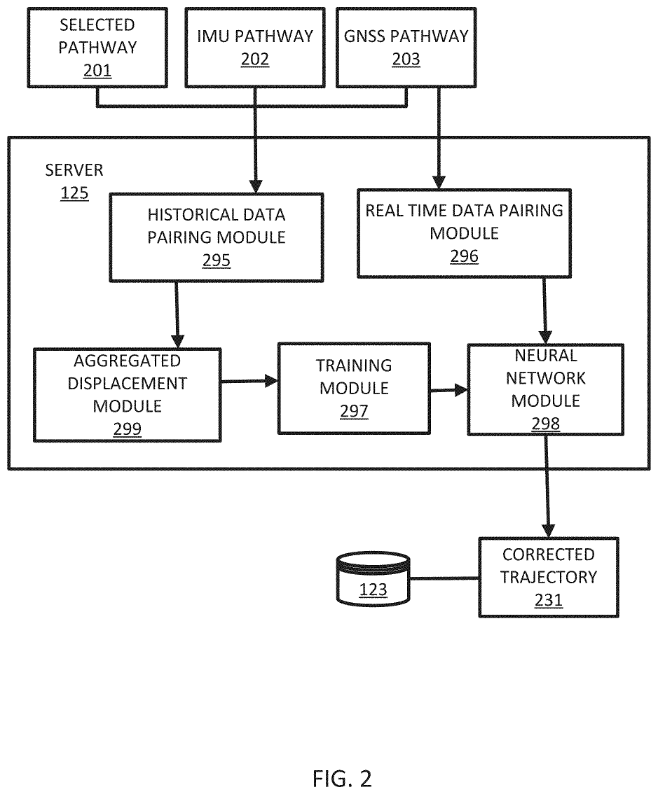

FIG. 2 illustrates a framework for defining a model configured to correct the trajectory of a mobile device 122 or a vehicle 124, the framework also capable of correcting the trajectory of a mobile device 122 or a vehicle 124 using a defined network. The framework of FIG. 2 includes a selected pathway 201, an IMU pathway 202, a GNSS pathway 203, a server 125, a corrected trajectory 231, and a database 123. The server 125 includes a historical data pairing module 295, a real time data pairing module 296, an aggregated displacement module 299, a training module 297, and a neural network module 298. Additional, different, or fewer components may be included.

The selected pathway 201 is any pathway for which ground truth location data is known. The ground truth data may describe the actual location of the pathway as determined previously. The ground truth may be determined by highly accurate equipment, for example, equipment have a higher accuracy and/or higher resolution that the first probe 101 and the second probe 102.

The IMU pathway 202 is a pathway of a mobile device 122 or vehicle 124 that is determined using an inertial measurement unit (IMU). The IMU may contain one or more accelerometers. The IMU may include one or more gyroscopes. The IMU may contain one or more magnetometers. The IMU may determine the pose of the mobile device 122 or vehicle 124. The IMU may determine the velocity of the mobile device 122 or vehicle 124. The IMU may collect inertial location data of the mobile device 122 or vehicle 124 at multiple locations, defining an IMU pathway of the mobile device 122 or vehicle 124. The IMU may be determined the location of the mobile device 122 or vehicle 124 using the pose and velocity of the mobile device 122 or vehicle 124. The location of the mobile device 122 or vehicle 124 may comprise a plurality of nodes. The nodes determined by the IMU may be a plurality of IMU coordinates identifying locations in space of the mobile device 122 or vehicle 124. In some embodiments, the IMU may further be configured to determine the pitch, roll, and yaw of the mobile device 122 or vehicle 124 at multiple locations.

The GNSS pathway 203 is a pathway of a mobile device 122 or vehicle 124 that is determined using GNSS. The GNSS pathway 203 may be generated by receiving GNSS signals and comparing the GNSS signals to a clock to determine the absolute or relative position of the mobile device 122 and/or vehicle 124. Absolute or relative positions may be determined at multiple locations, such that a GNSS pathway 203 is defined. In some embodiments the GNSS pathway 203 is based at least in part on inertial data collected by the second probe 102. The GNSS pathway 203 may be comprised of a plurality of nodes. The nodes of the GNSS pathway 203 may be a plurality of GNSS coordinates collected in space. The GNSS pathway 203 may be a plurality of undirected nodes. The undirected nodes may be a plurality of GNSS coordinates collected, without indication as to which GNSS coordinate comes relative to another sequentially. In some embodiments, the GNSS pathway 203 is based at least in part on inertial data. In some embodiments the inertial data used to determine the GNSS pathway 203 is data collected from a gyroscope.

The corrected trajectory 231 is a trajectory of a mobile device 122 or vehicle 124 determined by the defined model. The corrected trajectory 231 may be an estimated trajectory of the mobile device 122 or vehicle 124. The corrected trajectory 231 may be determined using the defined model and GNSS location information. The corrected trajectory 231 may comprise a GNSS pathway 203 that is calibrated by the model with data trained historically from IMU pathways 202 and ground truth location data of selected pathways 201. The corrected trajectory 231 may comprise a plurality of directed nodes. The plurality of directed nodes may comprise a plurality of GNSS coordinates arranged in a sequential order.

The historical data pairing module 295 receives the GNSS pathway 203, the IMU pathway 202, and the selected pathway 203. The historical data pairing module 295 pairs the GNSS pathway 203 and the IMU pathway 202 with the selected pathway 201 and the ground truth location data for the selected pathway 201. The historical pairing module 295 may send the paired GNSS pathway 203, IMU pathway 202, and selected pathway 201 and ground truth location data to the aggregated displacement module 299.

The real time data pairing module 296 receives the GNSS pathway 203. The real time data pairing module 296 may receive a predetermined number of previous GNSS nodes. The real time data pairing module 296 may send the GNSS pathway 203 to the neural network module 298. The real time data pairing module 296 may send the plurality of GNSS nodes to the neural network module 298.

The aggregated displacement module 299 is configured to calculate the aggregated displacement trajectory using at least the GNSS pathway 203, the IMU pathway 202, and the ground truth location data for the selected pathway 201. In some embodiments a first difference (d1) is calculated between the ground truth data for a selected pathway 201 and the GNSS pathway 203. In some embodiments a second difference (d2) is calculated between the ground truth data for the selected pathway 201 and the IMU pathway 202. The first difference and the second difference may be summed to define an aggregated displacement trajectory. That is, the aggregated displacement trajectory may be calculated using at least in part the difference between the ground truth data for the selected pathway and the GNSS pathway 203. The aggregated displacement trajectory may be calculated using at least in part the difference between the ground truth data for the selected pathway and the IMU pathway 202.

Equation 1 above may be used to determine which equation will be used to calculate the aggregated displacement trajectory. Equation 2 above may be used to calculate the aggregated displacement trajectory if Equation 1 above is satisfied.

In Equation 2, m is derived from y=mx+c using coordinates for d₁ and d₂ where d₁ is a coordinate in two-dimensional space on the GNSS pathway 203 and d₂ is a coordinate in two-dimensional space on an IMU pathway 202, wherein d₁ and d₂ are determined by the first probe 101 and second probe 102, respectfully, when the vehicle is in the same location (i.e., at the same point in time). For example, d₁ may be represented by coordinates x₁ and y₁. In Equation 2, d₃ is coordinates in two-dimensional space for the ground truth location data at the location at which the first probe 101 determines d₁ and the second probe 102 determines d₂. In Equation 2, x₃ and y₃ are a coordinate in a first plane and a coordinate in a second plane, respectively, of the location d₃. In Equation 2, d is the average of the distance between d₁ and d₃ and the distance between d₂ and d₃.

Further, Equation 2 is used to calculate the aggregated displacement trajectory when d₁ and d₂ are on opposite sides of d₃ when d₁, d₂, and d₃ are represented graphically with respect to time.

Equation 3 above may be used to determine the aggregated displacement trajectory when Equation 1 above is not satisfied.

In Equation 3, m is derived from y=mx+c using coordinates for d₁ and d₂ where d₁ is a coordinate in two-dimensional space on the GNSS pathway 203 and d₂ is a coordinate in two-dimensional space on the IMU pathway 202, wherein d₁ and d₂ are determined by the first probe 101 and second probe 102, respectfully, when the vehicle is in the same location (i.e., at the same point in time). For example, d₁ may be represented by coordinates x₁ and y₁. In Equation 3, d₃ is coordinates in two-dimensional space (i.e., x₃ and y₃) for the ground truth location data at the location at which the first probe 101 determines d₁ and the second probe 102 determines d₂. In Equation 3, x₃ and y₃ are a coordinate in a first plane and a coordinate in a second plane, respectively, of the location d₃. In Equation 3, d is the average of the distance between d₁ and d₃ and the distance between d₂ and d₃. Equation 3 may be used to calculate the aggregated displacement trajectory when d₁ and d₂ are on the same side of d₃ when d₁, d₂, and d₃ are represented graphically with respect to time.

The training module 297 is receives the aggregated displacement trajectory from the aggregated displacement module 299. The training module 297 is configured to define the model using the aggregated displacement trajectory. The model may be a graph convolutional network. The training module 297 may input the aggregated displacement trajectory into the model to understand the links between the points in the trajectory. The training module 297 may use a predetermined number of previous values for the aggregated displacement trajectory to define the model.

The neural network module 298 is configured to estimate a corrected trajectory of a mobile device 122 or vehicle 124. The neural network module 298 uses a defined model and at least a GNSS pathway 203 to determine a corrected trajectory of the mobile device 122 or vehicle 124. The neural network module 298 may use a predetermined number of previous GNSS pathway 203 positions to determine the corrected trajectory of the mobile device 122 or vehicle 124.

The server 125 may receive the IMU pathway 202 and the GNSS pathway 202 from the mobile device 122 or the vehicle 124. The server may receive the selected pathway from the mobile device 122, the vehicle 124, or the database 123.

In some embodiments, a historical data module receives the selected pathway 201, the IMU pathway 202, and the GNSS pathway. In this embodiment, the historical data pairing module 295 pairs the selected pathway 201, IMU pathway 202, and GNSS pathway 203 with ground truth location data for the selected pathway. The aggregated displacement module 299 calculates an aggregated displacement trajectory 204 using the selected pathway 201 and corresponding ground truth location data, the IMU pathway 202, and the GNSS pathway 203. In some embodiments a first difference (d1) is calculated between the ground truth data for the selected pathway and the IMU pathway. In some embodiments a second difference (d2) is calculated between the ground truth data for the selected pathway and the GNSS pathway.

The aggregated displacement trajectory 204 may be calculated using at least in part the difference between the ground truth data for the selected pathway and the IMU pathway 202. The aggregated displacement trajectory 204 may be calculated using at least in part the difference between the ground truth data for the selected pathway and the GNSS pathway 203. The aggregated displacement trajectory 204 may be determined using any combination of at least two of the following: pitch, roll, and yaw. The aggregated displacement trajectory 204 may be calculated using the equations mentioned hereinabove with reference to FIG. 1.

In some embodiments, the server includes a training module 297. The training module 297 may be configured to define a model configured to estimate the trajectory of a mobile device based on the aggregated displacement trajectory 204 and the ground truth data for the selected pathway. The model may be defined using a predetermined number of previous values for the aggregated displacement trajectory. For example, the model may be defined using the five previous values for the aggregated displacement trajectory.

In other embodiments, the framework of FIG. 2 may be configured to determine a corrected trajectory 231 of a mobile device 122 or a vehicle 124. In these embodiments, the server 125 includes a real time data pairing module 296. The real time data pairing module 296 receives the GNSS pathway 203 from the mobile device 122 or vehicle 124. The real time data pairing module 296 may send the GNSS pathway 203 to the neural network module 298. The neural network module 298 may execute the model using the GNSS pathway 203 and determine a corrected trajectory 231. The neural network module 298 may be configured to estimate the trajectory of the mobile device 122 or vehicle 124 using at least the GNSS pathway 203 and the defined model. The corrected trajectory 231 may be stored in the database 123. The corrected trajectory 231 may be used for operation of a vehicle 124.

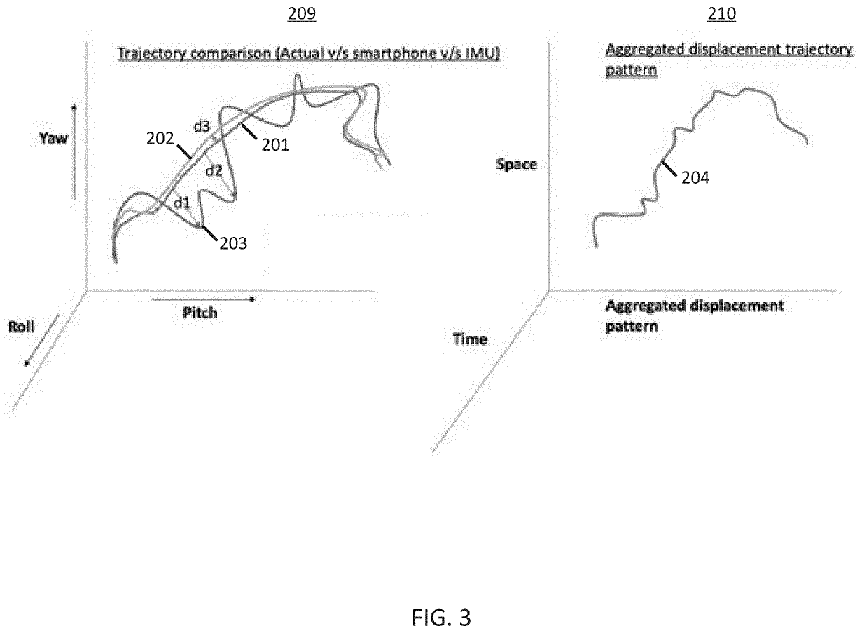

FIG. 3 is a graphical representation of a selected pathway 201, an IMU pathway 202, a GNSS pathway 203, and an aggregated displacement trajectory 204.

Graph 209 is a three-dimensional graph and has a first axis pitch, a second axis yaw and a third axis roll. Graph 209 has three plots. A first plot represents a selected pathway 201 indicating ground truth location data for the selected pathway. A second plot represents an IMU pathway 202 of a mobile device 122 or vehicles 124. A third plot represents a GNSS pathway 203 of a mobile device 122 or a vehicle 124. Accordingly, graph 209 indicates ground truth location data for a selected pathway 201, an IMU pathway 202 determined by a second probe 102, and a GNSS pathway 203 determined by a first probe 102 as a mobile device 122 or a vehicle 124 travels along a pathway.

In some embodiments, the aggregated displacement trajectory may be determined using any combination of the pitch, roll, and yaw of the mobile device 122 or vehicle 124. A first probe 102 may be configured to determine the pitch, roll, and/or yaw at a plurality of locations along the GNSS pathway 203. A second probe 103 may be configured to determine the pitch, roll, and/or yaw at a plurality of locations along the IMU pathway 202. Ground truth location information for the selected pathway 201 may include the pitch, roll, and/or yaw at a plurality of locations along the selected pathway 201. The aggregated displacement trajectory may be determined using at least two of the pitch, roll, and yaw of the first measured pathway collected by the first probe 101, at least two of the pitch, roll, and yaw of the second measured pathway collected by the second probe 102, and ground truth location data.

In graph 209, a first distance between a selected pathway 201 and a GNSS pathway 203 is represented by d₁ and a second distance between a selected pathway 201 and a GNSS 203 is represented by d₂. Further, a first distance between a selected pathway 201 and an IMU may be represented by d₃.

Graph 210 has a first axis aggregated displacement pattern, a second axis space, and a third axis time. Graph 210 has one line that represents an aggregated displacement trajectory 204. The aggregated displacement trajectory 204 may be calculated using any of the methods disclosed herein.

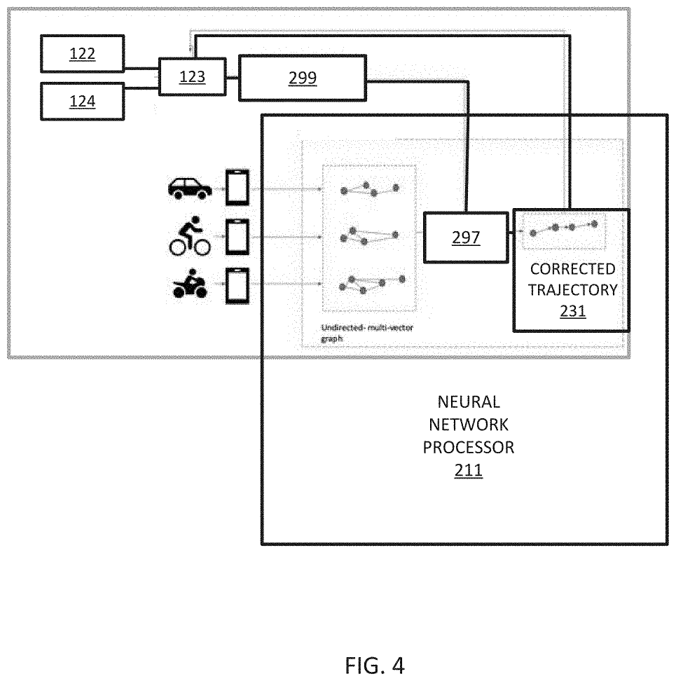

FIG. 4 illustrates an example framework for the system of defining a model for determining the trajectory of a mobile device according to an exemplary embodiment of the present disclosure. The framework of FIG. 4 includes one or more mobile devices 122 or vehicles 124, a database 123, an aggregated displacement module 299, a training module 297, a neural network processor 211, and a corrected trajectory 231. Additional, fewer, or different components may be included.

The mobile device 122 or vehicle 124 may determine a GNSS pathway 203 using a first probe 101. The GNSS pathway 203 may be comprised of a plurality of nodes. The nodes of the GNSS pathway 203 may be a plurality of GNSS coordinates collected in space. The GNSS pathway 203 may be a plurality of undirected nodes. The undirected nodes may be a plurality of GNSS coordinates collected, without indication as to which GNSS coordinate comes relative to another sequentially. In some embodiments, the GNSS pathway 203 is based at least in part on inertial data. In some embodiments the inertial data used to determine the GNSS pathway 203 is data collected from a gyroscope.

The mobile device 122 or vehicle 124 may determine an IMU pathway 202 using a second probe 102. The IMU pathway 202 may comprise a plurality of nodes. The IMU may determine the pose of the mobile device 122 or vehicle 124. The IMU may determine the velocity of the mobile device 122 or vehicle 124. The IMU may collect inertial location data of the mobile device 122 or vehicle 124 at multiple locations, such that an IMU pathway of the mobile device 122 or vehicle 124 is defined. The IMU may determine an IMU location of the mobile device 122 or vehicle 124 using the pose and velocity of the mobile device 122 or vehicle 124. The IMU pathway 202 of the mobile device 122 or vehicle 124 may comprise a plurality of nodes. The nodes determined by the IMU may be a plurality of IMU coordinates identifying locations of the mobile device 122 or vehicle 124. In some embodiments, the IMU may further be configured to determine the pitch, roll, and yaw of the mobile device 122 or vehicle 124 at multiple locations.

The aggregated displacement module 299 may calculate an aggregated displacement trajectory 204 using the ground truth data for the selected pathway 201, the IMU pathway 202, and the GNSS pathway 203 stored in the database 123. For example, the aggregated displacement trajectory 204 may be calculated using equation 1, equation 2, and equation 3 as disclosed herein.

The aggregated displacement trajectory 204 may then be sent to the training module 297 to define the model. The training module 297 may receive the aggregated displacement trajectory from the aggregated displacement module 299. The training module 297 is configured to define the model using the aggregated displacement trajectory. The training module 297 may input the aggregated displacement trajectory into the model. The model may be a graph convolutional network. The training module 297 may input the aggregated displacement trajectory into the model to understand the links between the points in the trajectory. The training module 297 may use a predetermined number of previous values for the aggregated displacement trajectory to define the model. The embeddings of the aggregated displacement trajectory 204 with respect to time may be used to define the model.

The neural network processor 211 may execute the defined model producing a corrected trajectory 231. The neural network processor may input the GNSS pathway 203 determined by the mobile device 122 or vehicle 124 into the defined model. The defined model may be stored in the database 123. The defined model may contain embeddings of aggregated displacement trajectory with respect to time. The neural network processor 211 may determine a corrected trajectory 231 of the mobile device 122 or vehicle 124 using at least the GNSS pathway 203 of the mobile device 122 or vehicle 124 and the defined model. The corrected trajectory 231 may be stored in the database 123.

The framework for determining a corrected trajectory according to the embodiment of FIG. 4 may include a plurality of mobile devices 122 and vehicles 124. An aggregated displacement trajectory 204 may be calculated for the movement of a mobile device 122 or a vehicle 124 over a plurality of selected pathways 201 having ground truth location data to define the model.

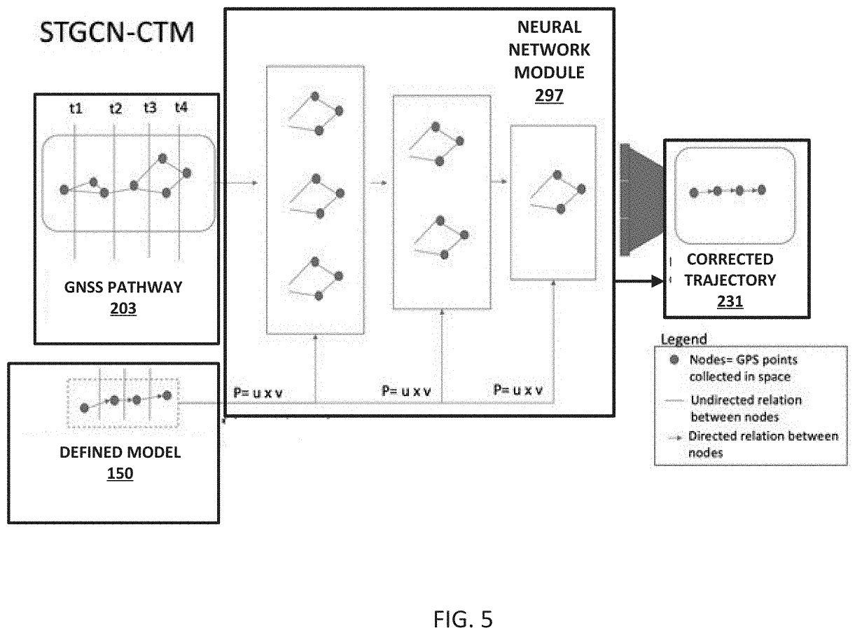

FIG. 5 illustrates an example framework for the system of determining a corrected trajectory of a mobile device according to an exemplary embodiment of the present disclosure. FIG. 5 includes a GNSS pathway 203, a model 150, a neural network module 297, and a corrected trajectory 231.

The GNSS pathway 203 may be comprised of a plurality of nodes. The nodes of the GNSS pathway 203 may be a plurality of GNSS coordinates collected in space. The GNSS pathway 203 may be a plurality of undirected nodes. The undirected nodes may be a plurality of GNSS coordinates collected, without indication as to which GNSS coordinate comes relative to another sequentially. In some embodiments, the GNSS pathway 203 is based at least in part on inertial data. In some embodiments the inertial data used to determine the GNSS pathway 203 is data collected from a gyroscope.

The defined model 150 may be a convolutional network. The defined model may be a spatio temporal graph convolutional network. The defined model may comprise trained embeddings of aggregated displacement trajectory in time. The defined model 150 may be configured to estimate a corrected trajectory 231 of the mobile device 122 or vehicle 124 using the trained embeddings of the aggregate displacement trajectory in time.

The neural network module 298 may be configured to determine a corrected trajectory 231 using at least the GNSS pathway 202 and the defined model 150. The neural network module 298 may input the GNSS pathway 202 determined by the mobile device 122 or vehicle 124 into the defined model 150. The defined model 150 may contain embeddings of aggregated displacement trajectory 204 with respect to time. The neural network processor 211 may determine a corrected trajectory 231 of the mobile device 122 or vehicle 124 using at least the GNSS location data of the mobile device 122 or vehicle 124 and the defined model.

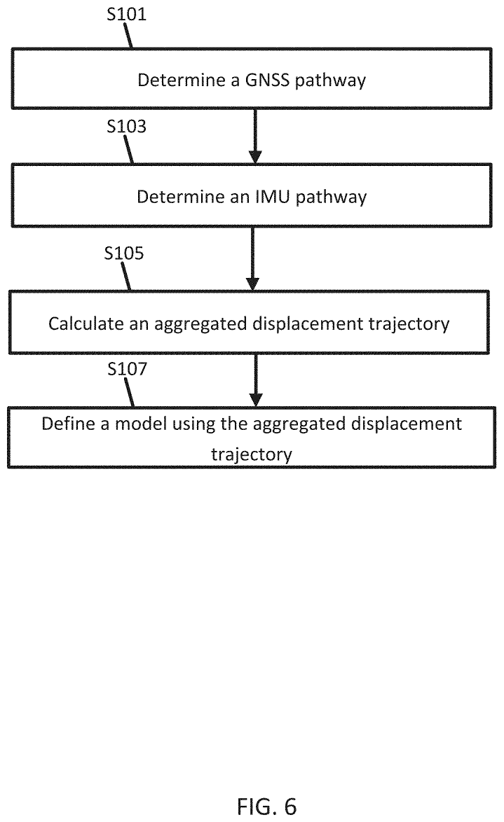

FIG. 6 illustrates an example flow chart for defining a model for estimating a trajectory according to an exemplary embodiment of the present disclosure. Additional, different, or fewer acts may be provided.

At act S101, the first probe 101 determines a GNSS pathway 203 of the mobile device 122 or vehicle 124. The first probe 101 may be a global navigation satellite system. The first probe 101 may determine a plurality of nodes along the GNSS pathway 203. The nodes may be a plurality of GNSS coordinates in space. The GNSS pathway 203 may be a plurality of undirected nodes. The undirected nodes may be a plurality of GNSS coordinates collected, without indication as to which GNSS coordinate comes relative to another sequentially. In some embodiments, the GNSS pathway 203 is based at least in part on inertial data. In some embodiments the inertial data used to determine the GNSS pathway 203 is data collected from a gyroscope. In some embodiments the first probe may further determine the pitch, roll, and/or yaw of the mobile device 122 or vehicle 124.

At act S103, the second probe 102 determines an IMU pathway of the mobile device 122 or vehicle 124. The second probe 102 may be an inertial measurement unit (IMU). The IMU may include one or more accelerometers and one or more gyroscopes. The IMU may include one or more magnetometers. The IMU may collect data at various locations defining an IMU pathway 202. The IMU may determine a pose and velocity of the mobile device 122 or vehicle 124. The IMU may determine an IMU pathway of the mobile device 122 or vehicle 124 using the determined pose and velocity. The IMU may determine the pitch, roll, and yaw of the mobile device 122 or vehicle 124.

At act S105, the aggregated displacement module 299 calculates an aggregated displacement trajectory 204. The aggregated displacement trajectory 204 may be calculated using at least the GNSS pathway 203, the IMU pathway 202, and ground truth location data for the selected pathway 201. In some embodiments a first difference (d1) is calculated between the ground truth data for a selected pathway 201 and the GNSS pathway 203. In some embodiments a second difference (d2) is calculated between the ground truth data for the selected pathway 201 and the IMU pathway 202. The first difference and the second difference may be summed to define an aggregated displacement trajectory. That is, the aggregated displacement trajectory may be calculated using at least in part the difference between the ground truth data for the selected pathway and the GNSS pathway 203. The aggregated displacement trajectory may be calculated using at least in part the difference between the ground truth data for the selected pathway and the IMU pathway 202.

In S107, the training module 297 defines a model using the aggregated displacement trajectory 204. The training module 297 may receive the aggregated displacement trajectory from the aggregated displacement module 299. The training module 297 is configured to define the model using the aggregated displacement trajectory. The training module 297 may input the aggregated displacement trajectory into the model. The model may be a graph convolutional network. The training module 297 may input the aggregated displacement trajectory into the model to understand the links between the points in the trajectory. The training module 297 may use a predetermined number of previous values for the aggregated displacement trajectory to define the model. The embeddings of the aggregated displacement trajectory 204 with respect to time may be used to define the model.

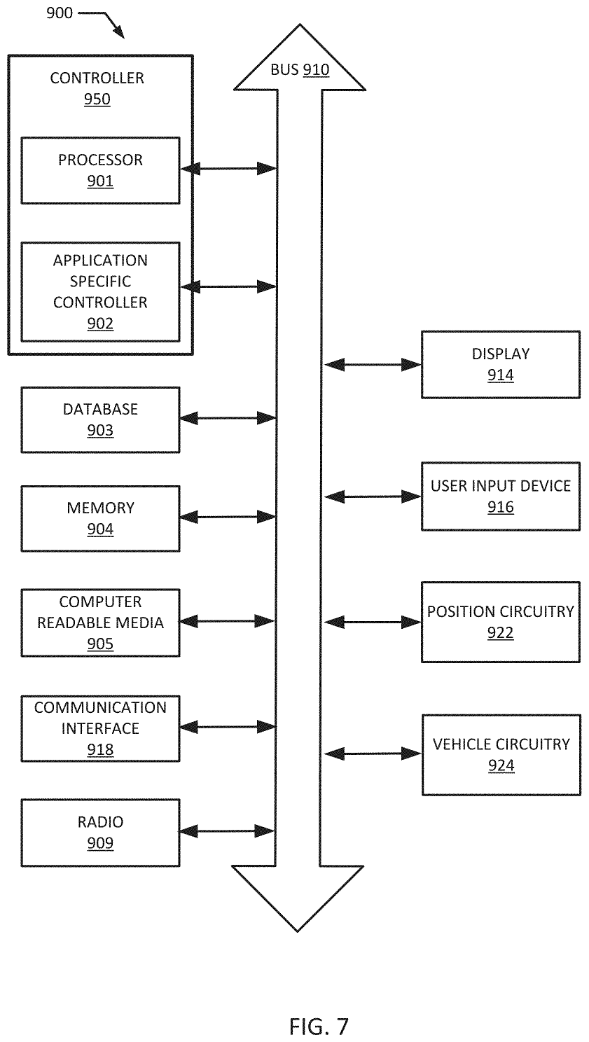

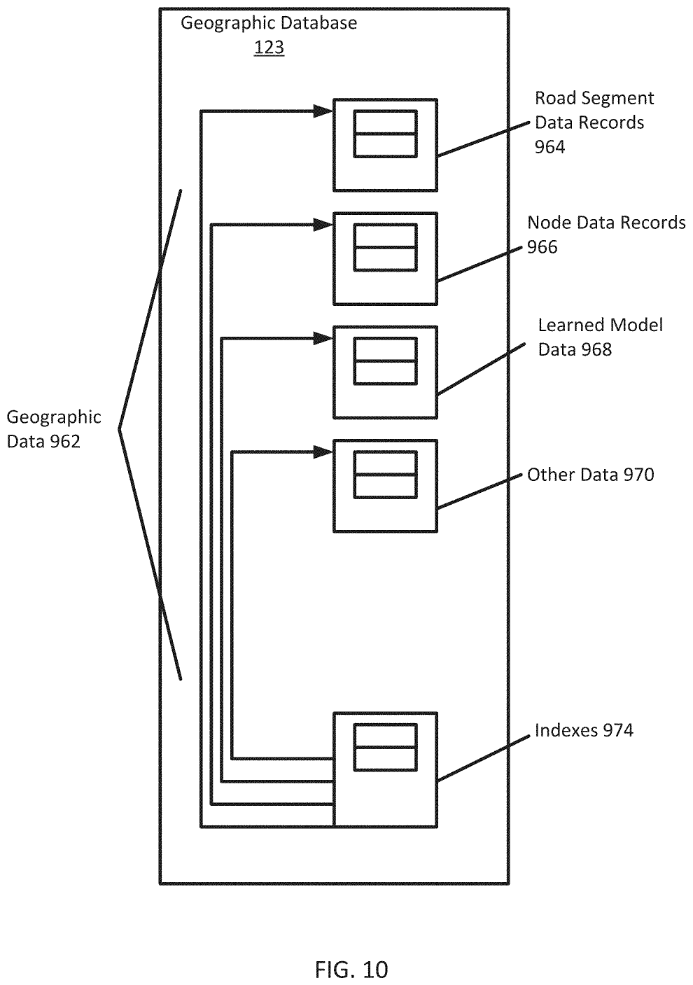

FIG. 7 illustrates an apparatus for defining a model configured to determine a corrected trajectory of a mobile device 122 or a vehicle 124 according to an exemplary embodiment of the present disclosure. The apparatus 900 includes a bus 910 facilitating communication between a controller that may be implemented by a processor 901 and/or an application specific controller 902, which may be referred to individually or collectively as the controller 950, and one or more other components including a database 903, a memory 904, a computer readable medium 905, a communication interface 918, a radio 909, a display 914, a user input device 916, position circuitry 922, and vehicle circuitry 924. The contents of the database 903 are described with respect to the database 123. The communication interface 918 may be connected to the internet and/or other networks. The other networks may be a content provider server and/or a service provider server. The vehicle circuitry 924 may include any of the circuitry and/or devices described with respect to FIG. 10. Additional, different, or fewer components may be included.

The communication interface 918 may include any operable connection. An operable connection may be one in which signals, physical communications, and/or logical communications may be sent and/or received. An operable connection may include a physical interface, an electrical interface, and/or a data interface. The communication interface provides for wireless and/or wired communications in any known or later developed format. The communication interface 918 may be connected to the internet and/or other networks. The other networks may be a content provider server or service provider server. In some embodiments, the communication interface 818 is configured to receive a first measured pathway and a second measured pathway. The communication interface 818 may receive the first measured pathway and the second measured pathway from the mobile device 122 and/or the vehicle 124.

The controller 950 may receive the first measured pathway and second measured pathway through the communications interface 918. The controller 950 may receive the first measured pathway and second measured pathway through the position circuitry 922. The first measured pathway may be a GNSS pathway 203. The second measured pathway may be an IMU pathway 202. The controller may store the first measured pathway and the second measured pathway in the database 903 and/or memory 904 for analysis. The controller 950 may access the database 903 and/or the memory 904 and retrieve the first measured pathway and the second measured pathway.

The first measured pathway and the second measured pathway may be stored in the database 903 and/or the memory 904. A model for determining a corrected trajectory of the mobile device 122 or vehicle 124 may be stored in the database 903 and/or the memory 904. Ground truth location data for a selected pathway 201 may be stored in the database 903 and/or memory 904. The controller 950 may access the database 903 or memory 904 and retrieve the model. The controller 950 may access the database 903 or memory 904 and retrieve the ground truth location data for the selected pathway 201.

The memory 904 may be a volatile memory or a non-volatile memory. The memory 904 may include one or more of a read only memory (ROM), random access memory (RAM), a flash memory, an electronic erasable program read only memory (EEPROM), or other type of memory. The memory 904 may be removable from the apparatus 900, such as a secure digital (SD) memory card.

The memory 904 and/or the computer readable medium 905 may include a set of instructions that can be executed to cause the controller to perform any one or more of the methods or computer-based functions disclosed herein. For example, the controller may calculate an aggregated displacement trajectory 204 (using the aggregated displacement module 299) of the mobile device 122 or vehicle 124. The controller may calculate the aggregated displacement trajectory 204 using the first measured pathway, second measured pathway, and ground truth location data for a selected pathway 201. The controller may calculate the aggregated displacement trajectory 204 using equation 1, equation 2, and equation 3 disclosed herein.

The controller 950 may define (using the training module 297) a model configured to determine a corrected trajectory 231 of the mobile device 122 or vehicle 124. The controller 950 may define the model using embeddings of the aggregated displacement trajectory 231. The controller may define the model using embeddings of the aggregated displacement trajectory with respect to time.

The position circuitry 922 may include a first probe 101 and a second probe 102. The first probe may be configured to determine a first measured pathway of the mobile device 122 or vehicle 124. The first measured pathway may be a GNSS pathway 203 of the mobile device 122 or vehicle 124. The first probe may be a global navigation satellite system configured to define the first measured pathway. The position circuitry 922 may include a second probe 102. The second probe may determine a second measured pathway of the mobile device 122 or vehicle 124. The second measured pathway may be an IMU pathway 202 of the mobile device 122 or vehicle 124. The second probe may be an inertial measurement unit configured to define the second measured pathway.

The apparatus 900 of FIG. 7 may further determine a corrected trajectory 231 of the mobile device 122 or vehicle 123. The apparatus 900 may determine a corrected trajectory 231 using the first measured pathway and a defined model 950.

The defined model may be a convolutional network. The defined model 150 may be a spatio temporal graph convolutional network. The defined model may include trained embeddings of aggregated displacement trajectories 204 with respect to time. The defined model 150 may be configured to determine the corrected trajectory 231 of a mobile device 122 or vehicle 124 using embeddings of aggregated displacement trajectories with respect to time.

The controller 950 may operate or execute the defined model 150. The controller 950 may input the first measured pathway into the defined model 150 (using the neural network model). The controller 950 may operate or execute the defined model determining a corrected trajectory 231 of the mobile device 122 or vehicle 124. The corrected trajectory 231 may be stored in the database 903.

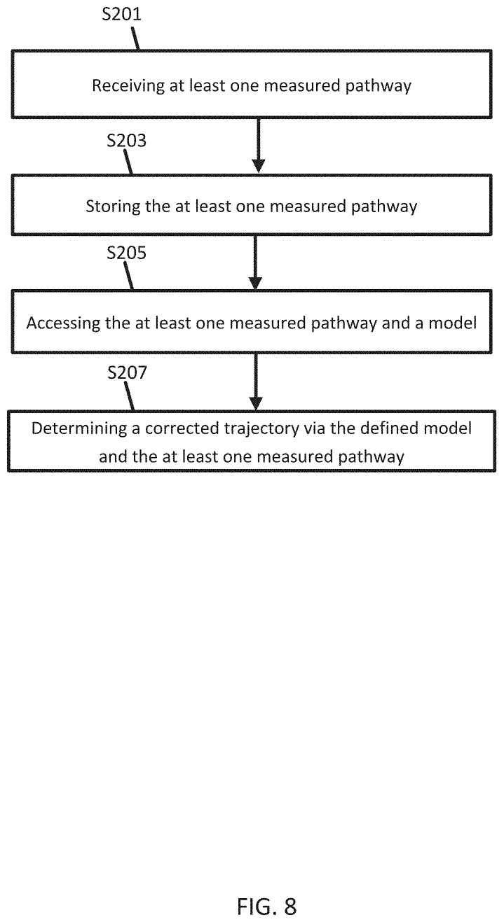

FIG. 8 illustrates an example flow chart for determining a corrected trajectory of a mobile device for the apparatus 900 of FIG. 8 according to an exemplary embodiment of the present disclosure.

At act S201, the controller 950 receives at least one measured pathway. The controller 950 may receive the at least one measured pathway through the communication interface 918. The controller may receive the at least one measured pathway through the position circuitry 922. The first measured pathway may be a GNSS pathway 203 of a mobile device 122 or a vehicle 124. The GNSS pathway 202 may comprise a plurality of GNSS coordinates determined by a global navigation satellite system.

At act S203, the controller 950 stores the first measured pathway in the database 903 or memory 904 of the apparatus 900. The controller 950 may store the first measured pathway in the database 903 or the memory 904 via the BUS 910.

At act S205, the controller 950 accesses the at least one measured pathway and the model stored in the database 903 or memory 904. The controller 950 may access the at least one measured pathway and the model stored in the database 903 or the memory 904 via the BUS 910.

At act S207, the controller 950 determines a corrected trajectory of the mobile device 122 or vehicle 124 via the defined model 150 and at least one measured pathway. The defined model 150 may be a convolutional network. The defined model 150 may be a spatio temporal graph convolutional network. The defined model 150 may include trained embeddings of aggregated displacement trajectories 204 with respect to time. The controller 950 may operate or execute the defined model 150 (using the neural network module 297). The controller may input the first measured pathway into the defined model to determine a corrected trajectory 231 of the mobile device 122 or vehicle 124.

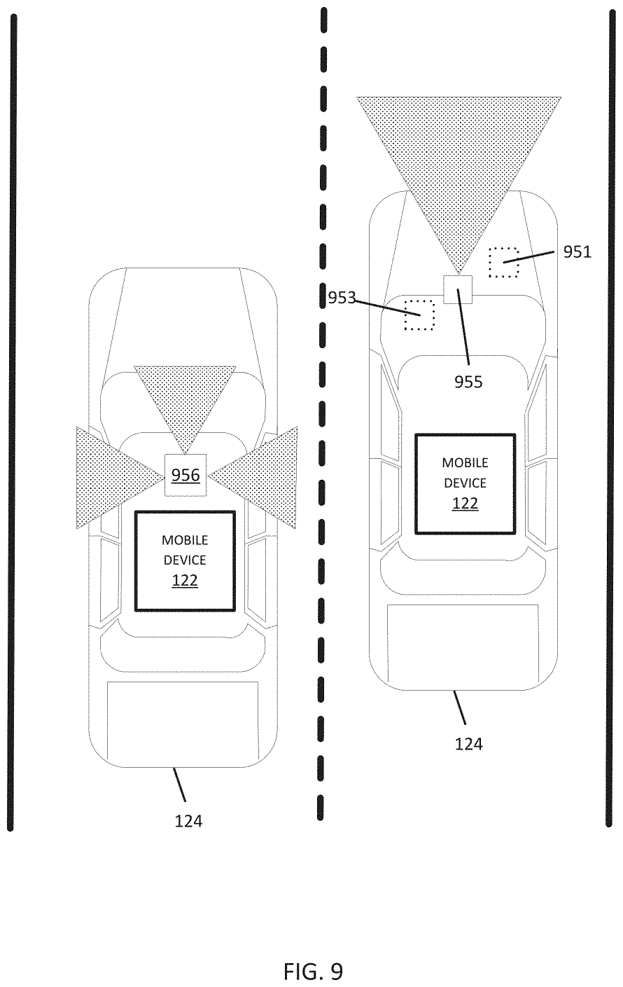

FIG. 9 illustrates an exemplary vehicle 124 of the system of FIG. 1. The vehicles 124 may include a variety of devices such as a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively or additionally, the one or more detectors or sensors may include an accelerometer built or embedded into or within the interior of the vehicle 124. The vehicle 124 may include one or more distance data detection device or sensor, such as a light detection and ranging (LiDAR) device. The distance data detection sensor may generate point cloud data. The distance data detection sensor may include a laser range finder that rotates a mirror directing a laser to the surroundings or vicinity of the collection vehicle on a roadway or another collection device on any type of pathway.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the internet.

The sensor array may include one or more sensors configured to detect surroundings of the vehicle 124. The sensor array may include multiple sensors. Example sensors include an optical distance system such as LiDAR 116, an image capture system 115 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera or another camera.

In some alternatives, additional sensors may be included in the vehicle 124. An engine sensor 111 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 113, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the output of the neural network or other model and other geographic data received from geographic database 123 and the server 125 to generate driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to the output of the neural network or other model and/or other geographic data received from geographic database 123 and the server 125 to generate driving commands or navigation commands. For example, the may provide a driving command to the vehicle 124 based on the output of the neural network or other model.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to the output of the neural network or other model and other geographic data received from geographic database 123 and the server 125 to generate driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the output of the neural network or other model and other geographic data received from geographic database 123 and the server 125 to generate driving commands or navigation commands.

The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments, which may be determined based on the output of the neural network or other model and other factors.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The geometric features may include curvature, slope, or other features. The curvature of a road segment describes a radius of a circle that in part would have the same path as the road segment. The slope of a road segment describes the difference between the starting elevation and ending elevation of the road segment. The slope of the road segment may be described as the rise over the run or as an angle.

The restrictions for traveling the roads or intersections may include turn restrictions, travel direction restrictions, speed limits, lane travel restrictions or other restrictions. Turn restrictions define when a road segment may be traversed onto another adjacent road segment. For example, when a node includes a “no left turn” restriction, vehicles are prohibited from turning left from one road segment to an adjacent road segment. Turn restrictions may also restrict that travel from a particular lane through a node. For example, a left turn lane may be designated so that only left turns (and not traveling straight or turning right) is permitted from the left turn late. Another example of a turn restriction is a “no U-turn” restriction.

Travel direction restriction designate the direction of travel on a road segment or a lane of the road segment. The travel direction restriction may designate a cardinal direction (e.g., north, southwest, etc.) or may designate a direction from one node to another node. The roadway features may include the number of lanes, the width of the lanes, the functional classification of the road, or other features that describe the road represented by the road segment. The functional classifications of roads may include different levels accessibility and speed. An arterial road has low accessibility but is the fastest mode of travel between two points. Arterial roads are typically used for long distance travel. Collector roads connect arterial roads to local roads. Collector roads are more accessible and slower than arterial roads. Local roads are accessible to individual homes and business. Local roads are the most accessible and slowest type of road.

The databases may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, and maneuver data.

In FIG. 10, the geographic database 123 may contain at least one road segment database record 304 (also referred to as “entity” or “entry”) for each road segment in a particular geographic region. The geographic database 123 may also include a node database record 306 (or “entity” or “entry”) for each node in a particular geographic region. The terms “nodes” and “segments” represent only one terminology for describing these physical geographic features, and other terminology for describing these features is intended to be encompassed within the scope of these concepts. The geographic database 123 may also include location fingerprint data for specific locations in a particular geographic region.

The geographic database 123 may include other kinds of data 310. The other kinds of data 310 may represent other kinds of geographic features or anything else. The other kinds of data may include POI data. For example, the POI data may include POI records comprising a type (e.g., the type of POI, such as restaurant, hotel, city hall, police station, historical marker, ATM, golf course, etc.), location of the POI, a phone number, hours of operation, etc.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

The geographic database 123 may also include other attributes of or about roads such as, for example, geographic coordinates, physical geographic features (e.g., lakes, rivers, railroads, municipalities, etc.) street names, address ranges, speed limits, turn restrictions at intersections, and/or other navigation related attributes (e.g., one or more of the road segments is part of a highway or toll way, the location of stop signs and/or stoplights along the road segments), as well as POIs, such as gasoline stations, hotels, restaurants, museums, stadiums, offices, automobile dealerships, auto repair shops, buildings, stores, parks, municipal facilities, other businesses, etc. The geographic database 123 may also contain one or more node data record(s) 306 which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data 302 may additionally or alternatively include other data records such as, for example, POI data records, topographical data records, cartographic data records, routing data, and maneuver data. Other contents of the database 123 may include temperature, altitude or elevation, lighting, sound or noise level, humidity, atmospheric pressure, wind speed, the presence of magnetic fields, electromagnetic interference, or radio- and micro-waves, cell tower and wi-fi information, such as available cell tower and wi-fi access points, and attributes pertaining to specific approaches to a specific location.

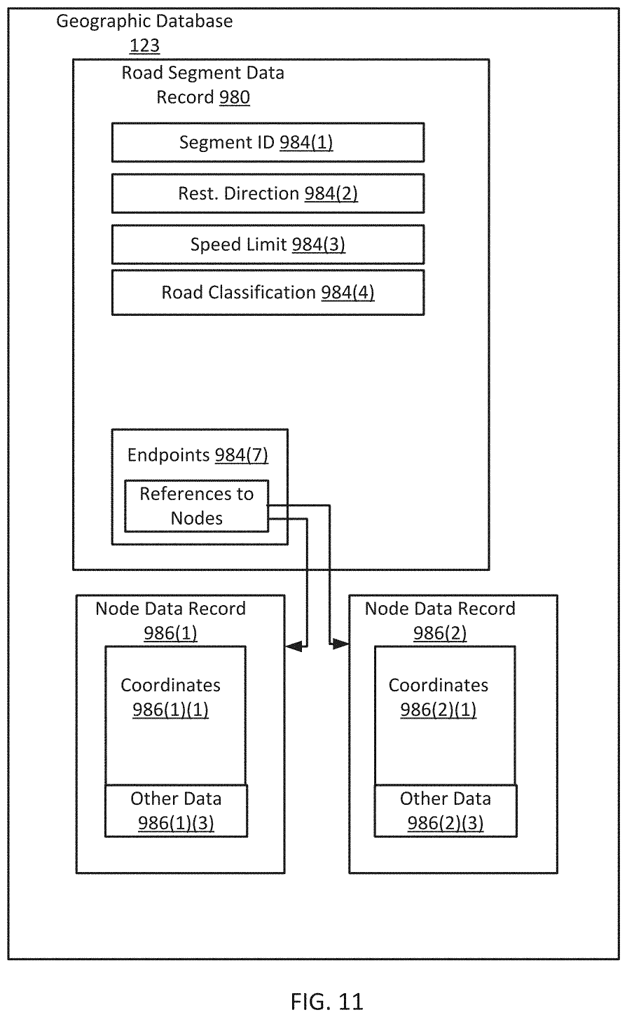

FIG. 11 shows some of the components of a road segment data record 304 contained in the geographic database 123 according to one embodiment. The road segment data record 304 may include a segment ID 304(1) by which the data record can be identified in the geographic database 123. Each road segment data record 304 may have associated with it information (such as “attributes”, “fields”, etc.) that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include classification data 304(4) indicating whether the represented road segment is part of a controlled access road (such as an expressway), a ramp to a controlled access road, a bridge, a tunnel, a toll road, a ferry, and so on. The road segment data record may include location fingerprint data, for example a set of sensor data for a particular location.

Additional schema may be used to describe road objects. The attribute data may be stored in relation to a link/segment 304, a node 306, a strand of links, a location fingerprint, an area, or a region. The geographic database 123 may store information or settings for display preferences. The geographic database 123 may be coupled to a display. The display may be configured to display the roadway network and data entities using different colors or schemes.

The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment.

The road segment data record 304 may also include or be associated with other data 304(7) that refer to various other attributes of the represented road segment. The various attributes associated with a road segment may be included in a single road segment record or may be included in more than one type of record which cross-references to each other. For example, the road segment data record 304 may include data identifying what turn restrictions exist at each of the nodes which correspond to intersections at the ends of the road portion represented by the road segment, the name, or names by which the represented road segment is identified, the street address ranges along the represented road segment, and so on.

FIG. 11 also shows some of the components of a node data record 306 that may be contained in the geographic database 123. Each of the node data records 306 may have associated information (such as “attributes”, “fields”, etc.) that allows identification of the road segment(s) that connect to it and/or its geographic position (e.g., its latitude and longitude coordinates). The node data records 306(1) and 306(2) include the latitude and longitude coordinates 306(1)(1) and 306(2)(1) for their node, the node data records 306(1) and 306(2) may also include other data 306(1)(3) and 306(2)(3) that refer to various other attributes of the nodes.

The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout a geographic region to observe features and/or record information about the roadway. Remote sensing, such as aerial or satellite photography, may be used. The database 123 may be incorporated in or connected to the server 125.

The geographic database 123 and the data stored within the geographic database 123 may be licensed or delivered on-demand. Other navigational services or traffic server providers may access the location fingerprint data, traffic data and/or the lane line object data stored in the geographic database 123.

The processor 901 may include a general processor, digital signal processor, an application specific integrated circuit (ASIC), field programmable gate array (FPGA), analog circuit, digital circuit, combinations thereof, or other now known or later developed processor. The processor 200 and/or processor 300 may be a single device or combinations of devices, such as associated with a network, distributed processing, or cloud computing.

The memory 904 may be a volatile memory or a non-volatile memory. The memory 904 may include one or more of a read only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 918 may include any operable connection. An operable connection may be one in which signals, physical communications, and/or logical communications may be sent and/or received. An operable connection may include a physical interface, an electrical interface, and/or a data interface. The communication interface 918 provides for wireless and/or wired communications in any now known or later developed format.

The databases 123 may include geographic data used for traffic and/or navigation-related applications. The geographic data may include data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the geographic data. The geographic data may include structured cartographic data or pedestrian routes.

The databases may include historical traffic speed data for one or more road segments. The databases may also include traffic attributes for one or more road segments. A traffic attribute may indicate that a road segment has a high probability of traffic congestion.

The input device 916 may be one or more buttons, keypad, keyboard, mouse, stylus pen, trackball, rocker switch, touch pad, voice recognition circuit, or other device or component for inputting data. The input device 916 and display 914 may be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The positioning circuitry 922 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 207 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A method of determining a trajectory of a mobile device, the method comprising:
accessing ground truth data for a selected pathway;
determining, via a global navigation satellite system (GNSS), a GNSS pathway of a first probe over the selected pathway;
determining, via an inertial measurement unit (IMU), an IMU pathway of a second probe over the selected pathway;
calculating an aggregated displacement trajectory of the mobile device along the selected pathway using the GNSS pathway, the IMU pathway, and the ground truth data for the selected pathway; and
defining a model configured to estimate the trajectory of a mobile device based on the aggregated displacement trajectory based on at least subsequent GNSS data.

2. The method of claim 1, further comprising:
calculating a difference between the ground truth data for the selected pathway and the IMU pathway, wherein the aggregated displacement trajectory is based, at least in part on the difference between the ground truth data for the selected pathway and the IMU pathway.

3. The method of claim 1, further comprising:
calculating a difference between the ground truth data for the selected pathway and the GNSS pathway, wherein the aggregated displacement trajectory is based, at least in part on the difference between the ground truth data for the selected pathway and the GNSS pathway.

4. The method of claim 1, further comprising:
determining inertial data collected by the second probe, wherein the GNSS pathway is based, at least in part, on the inertial data.

5. The method of claim 4, wherein the inertial data includes gyroscope data.

6. The method of claim 1, further comprising:
determining inertial data collected by the first probe, wherein the GNSS pathway is based, at least in part, on the inertial data.

7. The method of claim 1, wherein m is derived from y=mx+c using coordinates d₁ and d₂ where d₁ is a coordinate in two-dimensional space on the GNSS pathway and d₂ is a coordinate in two-dimensional space on the IMU pathway,
wherein x₃ is a coordinate in a first plane on the selected pathway and y₃ is a coordinate in a second plane on the selected pathway and x₃ and y₃ collectively represent a location d₃ in two-dimensional space on the selected pathway,
wherein d is an average of a distance between d₁ and d₃ and the distance between d₂ and d₃, and
wherein the aggregated displacement trajectory is calculated according to:
Σₖ₌₀ⁿ(ₖⁿ)Δd=\sqrt{x₃²−xₘ²+y₃²−yₘ²}.

8. The method of claim 1, further comprising:
inputting the subsequent GNSS data into the model; and
correcting the trajectory of the mobile device using the estimated trajectory from the model.

9. The method of claim 1, wherein the aggregated displacement trajectory is determined from any combination of at least two of a group comprising pitch, roll, and yaw.

10. The method of claim 1, wherein a predetermined number of previous values for the aggregated displacement trajectory define the model.

11. The method of claim 1, wherein the selected pathway is stored in memory.

12. An apparatus for developing a model for estimating trajectories, the apparatus comprising:
a communication interface configured to receive a first measured pathway and a second measured pathway;
a memory storing the first measured pathway, the second measured pathway, and a model; and
a processor configured to access the memory and calculate an aggregated displacement trajectory using the first measured pathway, second measured pathway, and a selected pathway.

13. The apparatus of claim 12,
wherein the first measured pathway is determined from a global navigation satellite system of a first mobile device,
wherein the second measured pathway is determined from an inertial measurement unit of a second mobile device, and
wherein the model is defined using the aggregated displacement trajectory and is configured to output a corrected trajectory based on the first measured pathway.

14. The apparatus of claim 13, wherein the aggregated displacement trajectory is calculated using pitch, roll, and yaw.

15. The apparatus of claim 13, further comprising:
calculating a first difference between the selected pathway and the first measured pathway, and
calculating a second difference between the selected pathway and the first measured pathway;
wherein the aggregated displacement trajectory is based, at least in part on the first difference and the second difference.

16. The apparatus of claim 15, wherein the first measured pathway is determined from inertial data collected by the first mobile device.

17. An apparatus for determining a corrected trajectory, the apparatus comprising:
a communication interface configured to receive at least one measured pathway;
a memory storing the measured pathway and a model;
a processor configured to access the memory and calculate an aggregated displacement trajectory using the at least one measured pathway and ground truth for a selected pathway; and
a neural network module configured to determine a corrected trajectory via the model and the aggregated displacement trajectory.

18. The apparatus of claim 17,
wherein the at least one measured pathway includes a first pathway determined from a global navigation satellite system and gyroscope of a mobile device and a second pathway determined from an inertial measurement unit other than the mobile device.

19. The apparatus of claim 18, wherein one or more driving operations are determined from the corrected trajectory.

20. The apparatus of claim 18, further comprising:
an electronic control unit of a self-driving autonomous vehicle connected to the processor and configured to perform one or more driving operations of the vehicle in response to the corrected trajectory.
